(19) United States
(12) Patent Application Publication
(10) Pub. No.: US 2025/0181977 A1
(43) Pub. Date: Jun. 5, 2025

(54) ARTIFICIAL INTELLIGENCE DEVICE FOR DATA AUGEMENTATION USING TRANSFORM FUNCTIONS AND CONTROL METHOD THEREOF

(71) Applicant: LG ELECTRONICS INC., Seoul (KR)

(72) Inventors: Sen JIA, Scarborough (CA); Homa FASHANDI, Toronto (CA)

(73) Assignee: LG ELECTRONICS INC., Seoul (KR)

(21) Appl. No.: 18/965,329

(22) Filed: Dec. 2, 2024

Related U.S. Application Data
(60) Provisional application No. 63/604,908, filed on Dec. 1, 2023.

(51) Int. Cl. G06N 20/00

(52) U.S. Cl. CPC G06N 20/00

(57) ABSTRACT

A method for controlling an artificial intelligence (AI) device can include obtaining a group of transform functions, a first training data set, a plurality of data augmentation policies including a first data augmentation policy including a first transform function from the group of transform functions for a first class and a second data augmentation policy including a second transform function from the group of transform functions for a second class, the first data augmentation policy being different than the second data augmentation policy. Also, the method can include generating first augmentation data by transforming images within the first training data set having the first class based on the first transform function, generating second augmentation data by transforming images within the first training data set having the second class based on the second transform function, generating a final training data for training an AI model.

### CROSS-REFERENCE TO RELATED APPLICATIONS

This non-provisional application claims priority under 35 U.S.C. § 119 (e) to U.S. Provisional Application No. 63/604,908, filed on Dec. 1, 2023, the entirety of which is hereby expressly incorporated by reference into the present application.

### BACKGROUND

### Field

The present disclosure relates to a data augmentation device and method, in the field of artificial intelligence (AI). Particularly, the method can provide class-specific data augmentation policies for increasing the diversity of training data and a more accurate AI model that can provide object classification related tasks and/or face recognition.

### Discussion of the Related Art

Artificial intelligence (AI) continues to transform various aspects of society and helps users by powering advancements in fields like robotics, transportation, and healthcare, such as leading to helpful robots, safter vehicles and accurate diagnoses.

For instance, various AI tasks may rely on an AI model to perform accurate object classification or facial recognition, in order to produce successful results, particularly in computer vision related tasks.

However, building such AI models often requires extensive training data. Creating training data for AI models can be a complex process with many challenges. For example, gathering sufficient data that is accurate, unbiased and representative of the real world can be difficult and expensive. Good training data is needed for developing AI models that are accurate and reliable.

Data augmentation is a strategy that can be used to increase the diversity and amount of training data, which can yield a more robust model for deployment. For example, data augmentation can include applying different image processing transformations on input data, such as rotation or shearing, in order to create more training data for training the AI model. However, existing data augmentation techniques apply the same transformation policies in a class agnostic fashion. In other words, the same transformations are used regardless of what type of object or item is in the input image that is used for creating augmented data.

However, not all transformations are created equal. For example, some image transformations may be helpful for training an AI model to identify a cat, but may not be as helpful for training the AI model to identify a car. Thus, even if the trained AI model may have a high average accuracy across all classes, the AI model may still have impaired accuracy when dealing with certain specific classes or objects. For example, the AI model may be good at dealing with faces and different types of animals, but may have impaired accuracy when dealing with different types of vehicles, etc.

Accordingly, there exists a need for being able to generate training data for training an AI model in a class-aware manner. For example, there exists a need for a solution that provides class-specific data augmentation policies for different classes during training of an AI model, in order to improve the accuracy for all of the classes.

Further, a need exists for a trained AI model that has improved accuracy across many different types of classes, which can be used for various down-stream AI tasks based on recognizing object or faces in an image, help accelerate the adoption of AI technologies across diverse fields, and help foster further advancements in AI.

### SUMMARY OF THE DISCLOSURE

The present disclosure has been made in view of the above problems and it is an object of the present disclosure to provide a device and method that can provide class-specific data augmentation policies, in the field of artificial intelligence (AI). Further, the method can train and produce a more accurate AI model that can provide object classification related tasks and/or face recognition.

An object of the present disclosure is to provide a method for controlling an artificial intelligence (AI) device that includes obtaining a group of transform functions, a first training data set, a plurality of data augmentation policies including a first data augmentation policy including a first transform function from the group of transform functions for a first class and a second data augmentation policy including a second transform function from the group of transform functions for a second class, the first data augmentation policy being different than the second data augmentation policy, generating first augmentation data by transforming images within the first training data set having the first class based on the first transform function, generating second augmentation data by transforming images within the first training data set having the second class based on the second transform function, generating a final training data for training an AI model.

It is another object of the present disclosure to provide a method for controlling an artificial intelligence (AI) device that includes obtaining, via a processor in the AI device, a group of transform functions, obtaining, via the processor, a first training data set including images and class labels, obtaining, via the processor, a plurality of data augmentation policies including at least a first data augmentation policy including a first transform function selected from among the group of transform functions for a first class within the first training data set and a second data augmentation policy including a second transform function selected from among the group of transform functions for a second class within the first training data set, the first data augmentation policy being different than the second data augmentation policy, generating, via the processor, first augmentation data by transforming images within the first training data set having the first class based on the first transform function included in the first data augmentation policy, generating, via the processor, second augmentation data by transforming images within the first training data set having the second class based on the second transform function included in the second data augmentation policy, generating, via the processor, a final training data set by combing the first training data set, the first augmentation data and the second augmentation data, and training, via the processor, an AI model based on the final training data set to generate a trained AI model.

Another object of the present disclosure is to provide a method that includes receiving, via at least one sensor in the AI device, an input image, inputting the input image into the trained AI model, and executing a function based on detecting an object or face within the input image by the trained AI model.

An object of the present disclosure is to provide a method that includes generating, via the processor, the plurality of data augmentation policies based on evaluating accuracy results of a baseline AI model trained on the first training data set without any additional data augmentation strategies, accuracy results of a first AI model trained according to a first transform setting corresponding to the first transform function and accuracy results of a second AI model trained according to a second transform setting corresponding to the second transform function.

Yet another object of the present disclosure is to provide a method, in which the generating the plurality of data augmentation policies further includes training a plurality of AI models to generate a plurality of trained AI models, each of the plurality of trained AI models being trained with different augmentation data generated by a different transform setting for a transform selected from among the group of transform functions, comparing accuracy results of each of the plurality of trained AI models for the first class with accuracy results of a baseline AI model trained based on the first training data set for the first class, and adding transform settings corresponding to trained AI models from among the plurality of trained AI models that have higher accuracy for the first class than the accuracy results of the baseline AI model for the first class to the first data augmentation policy.

An object of the present disclosure is to provide a method, in which the generating the plurality of data augmentation policies further includes comparing accuracy results of each of the plurality of trained AI models for the second class with accuracy results of the baseline AI model for the second class, and adding transform settings corresponding to trained AI models from among the plurality of trained AI models that have higher accuracy for the second class than the accuracy results of the baseline AI model for the second class to the second data augmentation policy.

An object of the present disclosure is to provide a method, in which at least one transform function among the group of transform functions has a small setting, a medium setting and large setting, the small setting configuring a first range of magnitude values for applying the at least one transform function, the medium setting configuring a second range of magnitude values for applying the at least one transform function that is greater than the first range of magnitude values corresponding to the small setting, and the large setting configuring a third range of magnitude values for applying the at least one transform function that is greater than the second range of magnitude values corresponding to the medium setting, and the plurality of trained AI models include a first trained AI model corresponding to the at least one transform function applied based on the small setting, a second trained AI model corresponding to the at least one transform function applied based on the medium setting, and a third trained AI model corresponding to the at least one transform function applied based on the large setting.

Another object of the present disclosure is to provide a method, in which the baseline AI model is trained on class-agnostic augmentation data.

An object of the present disclosure is to provide a method, in which the group of transform functions includes one or more of a shear_x transformation function, a shear_y transformation function, a translate_x transformation function, a translate_y transformation function, a rotate transformation function, a posterize transformation function, a solarize transformation function, a color transformation function, a brightness transformation function, a contrast transformation function, a sharpness transformation function, a flip transformation function, an invert transformation function, an equalize transformation function, an auto-contrast transformation function, a grayscale transformation function, a RandomResizedCrop transformation function, a BrightnessJitter transformation function, a ContrastJitter transformation function, a SaturationJitter transformation function, and a RandomPerspective transformation function.

Yet another object of the present disclosure is to provide a method, in which classes in the first training data set include one or more of face, plane, car, bird, cat, deer, dog, frog, horse, ship and truck.

Another object of the present disclosure is to provide a method, in which the trained AI model is based on deep layer aggregation (DLP) configured to connect information between different layers of a neural network.

An object of the present disclosure is to provide an artificial intelligence (AI) device includes a memory configured to store data augmentation policy information and training data, and a controller configured to obtain a group of transform functions, obtain a first training data set including images and class labels, obtain a plurality of data augmentation policies including at least a first data augmentation policy including a first transform function selected from among the group of transform functions for a first class within the first training data set and a second data augmentation policy including a second transform function selected from among the group of transform functions for a second class within the first training data set, the first data augmentation policy being different than the second data augmentation policy, generate first augmentation data by transforming images within the first training data set having the first class based on the first transform function included in the first data augmentation policy, generate second augmentation data by transforming images within the first training data set having the second class based on the second transform function included in the second data augmentation policy, generating, via the processor, a final training data set by combing the first training data set, the first augmentation data and the second augmentation data, and train an AI model based on the final training data set to generate a trained AI model.

In addition to the objects of the present disclosure as mentioned above, additional objects and features of the present disclosure will be clearly understood by those skilled in the art from the following description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 illustrates an AI device according to an embodiment of the present disclosure.

FIG. 2 illustrates an AI server according to an embodiment of the present disclosure.

FIG. 3 illustrates an AI device according to an embodiment of the present disclosure.

FIG. 4 shows an example flow chart for a method in the AI device according to an embodiment of the present invention.

FIG. 5 illustrates a class-agnostic data augmentation method of a comparative example.

FIG. 6 illustrates a class-dependent data augmentation method according to an embodiment of the present invention.

FIG. 7 shows an example flow chart for a method for controlling the AI device according to an embodiment of the present invention.

FIG. 8 shows an example flow chart for a method for controlling the AI device for evaluating transform settings and creating data augmentation policies according to an embodiment of the present invention.

FIG. 9, including parts (a)-(g), illustrates examples of an input training image and augmented training data generated based on the input training image using different transform functions according to an embodiment of the present invention.

### DETAILED DESCRIPTION OF THE EMBODIMENTS

Reference will now be made in detail to the embodiments of the present disclosure, examples of which are illustrated in the accompanying drawings.

Wherever possible, the same reference numbers will be used throughout the drawings to refer to the same or like parts.

Advantages and features of the present disclosure, and implementation methods thereof will be clarified through following embodiments described with reference to the accompanying drawings.

The present disclosure can, however, be embodied in different forms and should not be construed as limited to the embodiments set forth herein.

Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details.

Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description. In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms.

These terms are only used to distinguish one element from another. For example, a first element could be termed a second element, and, similarly, a second element could be termed a first element, without departing from the scope of the present disclosure.

Further, “X-axis direction,” “Y-axis direction” and “Z-axis direction” should not be construed by a geometric relation only of a mutual vertical relation and can have broader directionality within the range that elements of the present disclosure can act functionally.

The term “at least one” should be understood as including any and all combinations of one or more of the associated listed items.

For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship.

Hereinafter, the preferred embodiments of the present disclosure will be described in detail with reference to the accompanying drawings. All the components of each device or apparatus according to all embodiments of the present disclosure are operatively coupled and configured.

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and can mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network can include an input layer, an output layer, and optionally one or more hidden layers. Each layer includes one or more neurons, and the artificial neural network can include a synapse that links neurons to neurons. In the artificial neural network, each neuron can output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network can be to determine the model parameters that minimize a loss function. The loss function can be used as an index to determine optimal model parameters in the learning process of the artificial neural network.

Machine learning can be classified into supervised learning, unsupervised learning, and reinforcement learning according to a learning method.

The supervised learning can refer to a method of learning an artificial neural network in a state in which a label for learning data is given, and the label can mean the correct answer (or result value) that the artificial neural network must infer when the learning data is input to the artificial neural network. The unsupervised learning can refer to a method of learning an artificial neural network in a state in which a label for learning data is not given. The reinforcement learning can refer to a learning method in which an agent defined in a certain environment learns to select a behavior or a behavior sequence that maximizes cumulative compensation in each state.

Machine learning, which can be implemented as a deep neural network (DNN) including a plurality of hidden layers among artificial neural networks, is also referred to as deep learning, and the deep learning is part of machine learning. In the following, machine learning is used to mean deep learning.

Self-driving refers to a technique of driving for oneself, and a self-driving vehicle refers to a vehicle that travels without an operation of a user or with a minimum operation of a user.

For example, the self-driving can include a technology for maintaining a lane while driving, a technology for automatically adjusting a speed, such as adaptive cruise control, a technique for automatically traveling along a predetermined route, and a technology for automatically setting and traveling a route when a destination is set.

The vehicle can include a vehicle having only an internal combustion engine, a hybrid vehicle having an internal combustion engine and an electric motor together, and an electric vehicle having only an electric motor, and can include not only an automobile but also a train, a motorcycle, and the like.

At this time, the self-driving vehicle can be regarded as a robot having a self-driving function.

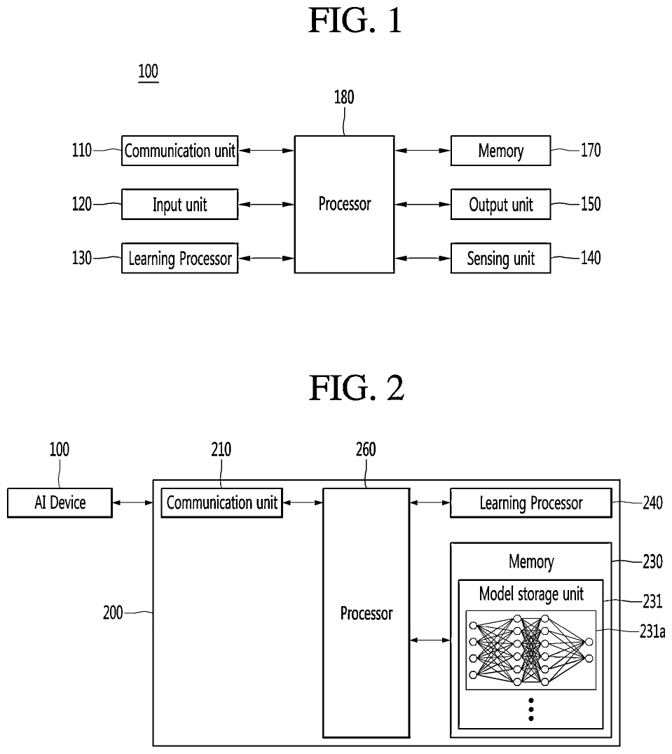

FIG. 1 illustrates an artificial intelligence (AI) device 100 according to one embodiment.

The AI device 100 can be implemented by a stationary device or a mobile device, such as a television (TV), a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like. However, other variations are possible.

Referring to FIG. 1, the AI device 100 can include a communication unit 110 (e.g., transceiver), an input unit 120 (e.g., touchscreen, keyboard, mouse, microphone, etc.), a learning processor 130, a sensing unit 140 (e.g., one or more sensors or one or more cameras), an output unit 150 (e.g., a display or speaker), a memory 170, and a processor 180 (e.g., a controller).

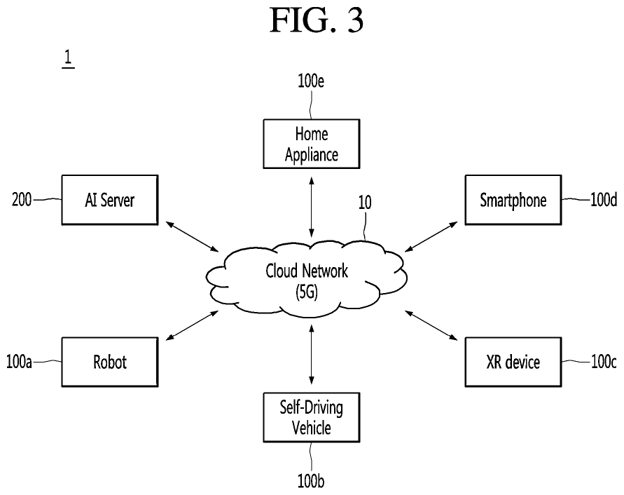

The communication unit 110 (e.g., communication interface or transceiver) can transmit and receive data to and from external devices such as other AI devices 100a to 100e and the AI server 200 (e.g., FIGS. 2 and 3) by using wire/wireless communication technology. For example, the communication unit 110 can transmit and receive sensor information, a user input, a learning model, and a control signal to and from external devices.

The communication technology used by the communication unit 110 can include GSM (Global System for Mobile communication), CDMA (Code Division Multi Access), LTE (Long Term Evolution), 5G, WLAN (Wireless LAN), Wi-Fi (Wireless-Fidelity), BLUETOOTH, RFID (Radio Frequency Identification), Infrared Data Association (IrDA), ZIGBEE, NFC (Near Field Communication), and the like.

The input unit 120 can acquire various kinds of data.

At this time, the input unit 120 can include a camera for inputting a video signal, a microphone for receiving an audio signal, and a user input unit for receiving information from a user. The camera or the microphone can be treated as a sensor, and the signal acquired from the camera or the microphone can be referred to as sensing data or sensor information.

The input unit 120 can acquire a learning data for model learning and an input data to be used when an output is acquired by using a learning model. The input unit 120 can acquire raw input data. In this situation, the processor 180 or the learning processor 130 can extract an input feature by preprocessing the input data.

The learning processor 130 can learn a model composed of an artificial neural network by using learning data. The learned artificial neural network can be referred to as a learning model. The learning model can be used to infer a result value for new input data rather than learning data, and the inferred value can be used as a basis for determination to perform a certain operation.

At this time, the learning processor 130 can perform AI processing together with the learning processor 240 of the AI server 200.

At this time, the learning processor 130 can include a memory integrated or implemented in the AI device 100. Alternatively, the learning processor 130 can be implemented by using the memory 170, an external memory directly connected to the AI device 100, or a memory held in an external device.

The sensing unit 140 can acquire at least one of internal information about the AI device 100, ambient environment information about the AI device 100, and user information by using various sensors.

Examples of the sensors included in the sensing unit 140 can include a proximity sensor, an illuminance sensor, an acceleration sensor, a magnetic sensor, a gyro sensor, an inertial sensor, an RGB sensor, an IR (infrared) sensor, a fingerprint recognition sensor, an ultrasonic sensor, an optical sensor, a camera, a microphone, a lidar, and a radar.

The output unit 150 can generate an output related to a visual sense, an auditory sense, or a haptic sense.

At this time, the output unit 150 can include a display unit for outputting time information, a speaker for outputting auditory information, and a haptic module for outputting haptic information.

The memory 170 can store data that supports various functions of the AI device 100. For example, the memory 170 can store input data acquired by the input unit 120, learning data, a learning model, a learning history, and the like.

The processor 180 can determine at least one executable operation of the AI device 100 based on information determined or generated by using a data analysis algorithm or a machine learning algorithm. The processor 180 can control the components of the AI device 100 to execute the determined operation. For example, the processor 180 can implement class-aware data augmentation policies and strategies for training an AI model. Also, processor 180 can train an AI model with class-specific training data to generate a trained AI mode that has improved accuracy in various tasks, such as object classification and identification or face recognition.

To this end, the processor 180 can request, search, receive, or utilize data of the learning processor 130 or the memory 170. The processor 180 can control the components of the AI device 100 to execute the predicted operation or the operation determined to be desirable among the at least one executable operation.

When the connection of an external device is required to perform the determined operation, the processor 180 can generate a control signal for controlling the external device and can transmit the generated control signal to the external device.

The processor 180 can acquire information from the user input and can determine an answer, carry out an action or movement, or a recommended item or action based on the acquired information.

The processor 180 can acquire the information corresponding to the user input by using at least one of a speech to text (STT) engine for converting speech input into a text string or a natural language processing (NLP) engine for acquiring intention information of a natural language.

At least one of the STT engine or the NLP engine can be configured as an artificial neural network, at least part of which is learned according to the machine learning algorithm. At least one of the STT engine or the NLP engine can be learned by the learning processor 130, can be learned by the learning processor 240 of the AI server 200 (see FIG. 2), or can be learned by their distributed processing.

The processor 180 can collect history information including user profile information, the operation contents of the AI device 100 or the user's feedback on the operation and can store the collected history information in the memory 170 or the learning processor 130 or transmit the collected history information to the external device such as the AI server 200. The collected history information can be used to update the learning model.

The processor 180 can control at least part of the components of AI device 100 to drive an application program stored in memory 170. Furthermore, the processor 180 can operate two or more of the components included in the AI device 100 in combination to drive the application program.

FIG. 2 illustrates an AI server according to one embodiment.

Referring to FIG. 2, the AI server 200 can refer to a device that learns an artificial neural network by using a machine learning algorithm or uses a learned artificial neural network. The AI server 200 can include a plurality of servers to perform distributed processing, or can be defined as a 5G network, 6G network or other communications network. At this time, the AI server 200 can be included as a partial configuration of the AI device 100, and can perform at least part of the AI processing together.

The AI server 200 can include a communication unit 210, a memory 230, a learning processor 240, a processor 260, and the like.

The communication unit 210 can transmit and receive data to and from an external device such as the AI device 100.

The memory 230 can include a model storage unit 231. The model storage unit 231 can store a learning or learned model (or an artificial neural network 231a) through the learning processor 240.

The learning processor 240 can learn the artificial neural network 231a by using the learning data. The learning model can be used in a state of being mounted on the AI server 200 of the artificial neural network, or can be used in a state of being mounted on an external device such as the AI device 100.

The learning model can be implemented in hardware, software, or a combination of hardware and software. If all or part of the learning models are implemented in software, one or more instructions that constitute the learning model can be stored in the memory 230.

The processor 260 can infer the result value for new input data by using the learning model and can generate a response or a control command based on the inferred result value.

FIG. 3 illustrates an AI system 1 including a terminal device according to one embodiment.

Referring to FIG. 3, in the AI system 1, at least one of an AI server 200, a robot 100a, a self-driving vehicle 100b, an XR (extended reality) device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, can be referred to as AI devices 100a to 100e. The AI server 200 of FIG. 3 can have the configuration of the AI server 200 of FIG. 2.

According to an embodiment, the method can be implemented as an application or program that can be downloaded or installed in the smartphone 100d, which can communicate with the AI server 200, but embodiments are not limited thereto.

The cloud network 10 can refer to a network that forms part of a cloud computing infrastructure or exists in a cloud computing infrastructure. The cloud network 10 can be configured by using a 3G network, a 4G or LTE network, a 5G network, a 6G network, or other network.

For instance, the devices 100a to 100e and 200 configuring the AI system 1 can be connected to each other through the cloud network 10. In particular, each of the devices 100a to 100e and 200 can communicate with each other through a base station, but can directly communicate with each other without using a base station.

The AI server 200 can include a server that performs AI processing and a server that performs operations on big data.

The AI server 200 can be connected to at least one of the AI devices constituting the AI system 1, that is, the robot 100a, the self-driving vehicle 100b, the XR device 100c, the smartphone 100d, or the home appliance 100e through the cloud network 10, and can assist at least part of AI processing of the connected AI devices 100a to 100e.

At this time, the AI server 200 can learn the artificial neural network according to the machine learning algorithm instead of the AI devices 100a to 100e, and can directly store the learning model or transmit the AI model to the AI devices 100a to 100e.

At this time, the AI server 200 can receive input data from the AI devices 100a to 100e, can infer the result value for the received input data by using the learning model, can generate a response or a control command based on the inferred result value, and can transmit the response or the control command to the AI devices 100a to 100e. Each AI device 100a to 100e can have the configuration of the AI device 100 of FIGS. 1 and 2 or other suitable configurations.

Alternatively, the AI devices 100a to 100e can infer the result value for the input data by directly using the learning model, and can generate the response or the control command based on the inference result.

Hereinafter, various embodiments of the AI devices 100a to 100e to which the above-described technology is applied will be described. The AI devices 100a to 100e illustrated in FIG. 3 can be regarded as a specific embodiment of the AI device 100 illustrated in FIG. 1.

According to an embodiment, the home appliance 100e can be a smart television (TV), smart microwave, smart oven, smart refrigerator or other display device, which can implement one or more of a data augmentation method, a question and answering system or a recommendation system. The method can be the form of an executable application or program.

The robot 100a, to which the AI technology is applied, can be implemented as an entertainment robot, a guide robot, a carrying robot, a cleaning robot, a wearable robot, a pet robot, an unmanned flying robot, or the like.

The robot 100a can include a robot control module for controlling the operation, and the robot control module can refer to a software module or a chip implementing the software module by hardware.

The robot 100a can acquire state information about the robot 100a by using sensor information acquired from various kinds of sensors, can detect (recognize) surrounding environment and objects, can generate map data, can determine the route and the travel plan, can determine the response to user interaction, or can determine the operation.

The robot 100a can use the sensor information acquired from at least one sensor among the lidar, the radar, and the camera to determine the travel route and the travel plan.

The robot 100a can perform the above-described operations by using the learning model composed of at least one artificial neural network. For example, the robot 100a can recognize the surrounding environment and the objects by using the AI model, and can determine the operation by using the recognized surrounding information or object information. The learning model can be learned directly from the robot 100a or can be learned from an external device such as the AI server 200.

At this time, the robot 100a can perform the operation by generating the result by directly using the AI model, but the sensor information can be transmitted to the external device such as the AI server 200 and the generated result can be received to perform the operation.

The robot 100a can use at least one of the map data, the object information detected from the sensor information, or the object information acquired from the external apparatus to determine the travel route and the travel plan, and can control the driving unit such that the robot 100a travels along the determined travel route and travel plan. Further, the robot 100a can determine an action to pursue or an item to recommend. Also, the robot 100a can generate an answer in response to a user query. The answer can be in the form of natural language.

The map data can include object identification information about various objects arranged in the space in which the robot 100a moves. For example, the map data can include object identification information about fixed objects such as walls and doors and movable objects such as pollen and desks. The object identification information can include a name, a type, a distance, and a position.

In addition, the robot 100a can perform the operation or travel by controlling the driving unit based on the control/interaction of the user. At this time, the robot 100a can acquire the intention information of the interaction due to the user's operation or speech utterance, and can determine the response based on the acquired intention information, and can perform the operation.

The robot 100a, to which the AI technology and the self-driving technology are applied, can be implemented as a guide robot, a carrying robot, a cleaning robot (e.g., an automated vacuum cleaner), a wearable robot, an entertainment robot, a pet robot, an unmanned flying robot (e.g., a drone or quadcopter), or the like.

The robot 100a, to which the AI technology and the self-driving technology are applied, can refer to the robot itself having the self-driving function or the robot 100a interacting with the self-driving vehicle 100b.

The robot 100a having the self-driving function can collectively refer to a device that moves for itself along the given movement line without the user's control or moves for itself by determining the movement line by itself.

The robot 100a and the self-driving vehicle 100b having the self-driving function can use a common sensing method to determine at least one of the travel route or the travel plan. For example, the robot 100a and the self-driving vehicle 100b having the self-driving function can determine at least one of the travel route or the travel plan by using the information sensed through the lidar, the radar, and the camera.

The robot 100a that interacts with the self-driving vehicle 100b exists separately from the self-driving vehicle 100b and can perform operations interworking with the self-driving function of the self-driving vehicle 100b or interworking with the user who rides on the self-driving vehicle 100b.

In addition, the robot 100a interacting with the self-driving vehicle 100b can control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b can monitor the user boarding the self-driving vehicle 100b, or can control the function of the self-driving vehicle 100b through the interaction with the user. For example, when it is determined that the driver is in a drowsy state, the robot 100a can activate the self-driving function of the self-driving vehicle 100b or assist the control of the driving unit of the self-driving vehicle 100b. The function of the self-driving vehicle 100b controlled by the robot 100a can include not only the self-driving function but also the function provided by the navigation system or the audio system provided in the self-driving vehicle 100b.

Alternatively, the robot 100a that interacts with the self-driving vehicle 100b can provide information or assist the function to the self-driving vehicle 100b outside the self-driving vehicle 100b. For example, the robot 100a can provide traffic information including signal information and the like, such as a smart signal, to the self-driving vehicle 100b, and automatically connect an electric charger to a charging port by interacting with the self-driving vehicle 100b like an automatic electric charger of an electric vehicle.

According to an embodiment, the AI device 100 can provide class-specific data augmentation policies for increasing the diversity of training data, and can train and generate a trained AI model using the augmented data that can provide object classification related tasks and/or face recognition with improved accuracy.

According to another embodiment, the AI device 100 can be integrated into an infotainment system of the self-driving vehicle 100b, which can recognize different users and recommend content, provide personalized services or provide answers based on various input modalities, the content can include one or more of audio recordings, video, music, pod casts, etc., but embodiments are not limited thereto. Also, the AI device 100 can be integrated into an infotainment system of the manual or human-driving vehicle.

As discussed above, building an accurate and robust AI model often requires extensive training data, and gathering sufficient training data that is accurate and unbiased can be difficult and expensive.

According to an embodiment, the AI device and method can improve the performance of an artificial intelligence (AI) model, particularly a model that is trained on image data. For example, the method can provide an improved approach to data augmentation that enhances model accuracy and robustness by tailoring different augmentation strategies to specific classes within a training data set.

Existing data augmentation (DA) techniques may apply a uniform set of transformations, such as rotation, scaling, or shearing, to all images in a data set, regardless of the class to which they belong. This “class-agnostic” approach aims to increase the diversity of the training data and improve the AI model's ability to generalize to unseen examples. However, the effectiveness of different data augmentation transformations can vary significantly depending on the specific characteristics of each class.

Applying the same data augmentation policy to all classes may therefore lead to suboptimal performance, as certain transformations may be beneficial for some classes while being detrimental to others. For example, color shifting a car image to be blue to create augmented training data may be helpful for teaching the AI model to get better at identifying different types of cars, but color shifting a face image to be blue might confuse the AI model and impair its ability to identify different types of faces.

In more detail, existing techniques for data augmentation can include AutoAug, RandAug, TrivialAug, and AugMix. For example, AutoAug applies empirical search on 16 transform functions with different strength magnitudes to find the optimal combinations, and picks the top 5 combinations that work best, most of which are color-based transformations. RandAug is similar to AutoAug except at each step it randomly draws N functions out of a pool of available transformation functions (e.g., 14 transformation functions) and applies them to improve training of the AI model. TrivialAug further simplifies RandAug by sampling one transform function at each step, in which only one function is randomly selected from among a pool of available transformation functions. Also, AugMix applies different functions on the same input and then merges all of the augmented outputs together. In other words, AugMix creates new training images by mixing together different versions of the same image with various changes applied. However, these techniques are carried out in a class agnostic manner that does not consider what type of object is included in the original input training image.

To address these issues, according to an embodiment, the AI device and method can use a class-aware data augmentation approach. This approach can include applying different image transformations conditionally, based on the class label of the input image. By tailoring the data augmentation strategy to each class, the augmentation process can be further optimized to enhance the AI model's ability to learn discriminative features that are unique for each class, thereby improving overall accuracy across many different classes.

For example, in a training data set including images of different kinds of animals and vehicles, rotating images of animals might be beneficial for producing an AI model that can identify animals with high accuracy, while shearing images of vehicles might be more effective for teaching the AI model to identify vehicles.

As a simplified example for explanation, the method can allow for the creation of a data augmentation policy that applies rotations specifically to cat images and shearing specifically to car images, but embodiments are not limited thereto. In other words, a certain set of transformations can be applied to a one type of class (e.g., cats) and a different set of transformations can be applied to another type of class (e.g., cars) for creating augmented training data to train the AI model. This class-specific approach can help ensure that each class receives the most effective augmentation strategy, leading to improved performance and accuracy.

In another example, according to an embodiment, the method can extend to tasks such as facial recognition, where images including a face can be considered to belong to a one class (e.g., a “face” class). For this “face” class, a specialized data augmentation policy can be provided that addresses the unique challenges of facial recognition, such as variations in pose, lighting, and expression, etc. By tailoring the data augmentation strategy to the specific characteristics of faces, the accuracy and robustness of the AI model can be improved for the specific class for faces.

According to an embodiment, the method can provide a class-aware data augmentation approach. For example, conditional augmentation can be carried out where specific transformations are applied based on the class label of the input image. Further, the method can include determining optimal data augmentation policies for each class, which is discussed in more detail below.

In this way, the method can provide more effective and efficient training of image-based AI models. This class-aware approach produces an improved AI model that has better accuracy across many different classes, which can be used in various domains, including image classification, object detection, facial recognition and other downstream AI applications that are based on recognizing objects or faces in an image.

In more detail, instead of applying the same set of transformations to all images in a data set, the method can improve the efficacy of data augmentation by providing a class-specific data augmentation policy for each class during model training.

For example, a distinct set of image transformations (each of which can be applied with a specified strength) can defined and applied exclusively to a particular class. For instance, in a data set with images of cats, dogs, and birds, rotations might be beneficial for cats, shearing for dogs, and horizontal flips for birds. In other words, the method can allow each class to receive its own unique set of transformations, optimized for its specific characteristics. According to an embodiment, the data augmentation method can be referred to as ClassAug, but embodiments are not limited thereto.

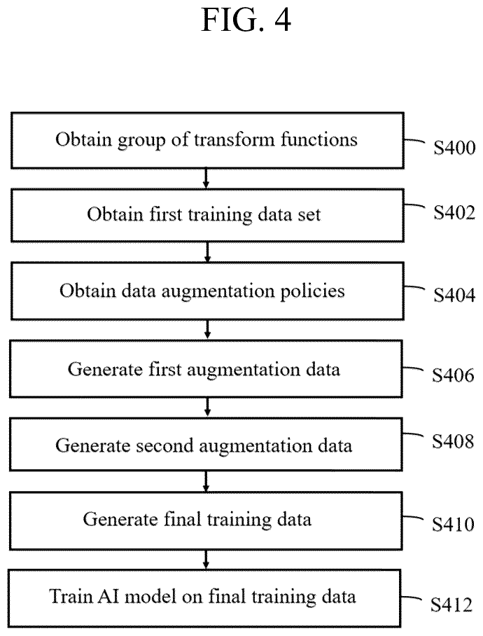

FIG. 4 shows an example flow chart of a method according to an embodiment. For example, the AI device 100 can be configured with a method for controlling an artificial intelligence (AI) device that includes obtaining, via a processor in the AI device, a group of transform functions (e.g., S400), obtaining, via the processor, a first training data set including images and class labels (e.g., S402), and obtaining, via the processor, a plurality of data augmentation policies including at least a first data augmentation policy including a first transform function selected from among the group of transform functions for a first class within the first training data set and a second data augmentation policy including a second transform function selected from among the group of transform functions for a second class within the first training data set, the first data augmentation policy being different than the second data augmentation policy (e.g., S404).

Also, the method can further include generating, via the processor, first augmentation data by transforming images within the first training data set having the first class based on the first transform function included in the first data augmentation policy (e.g., S406), generating, via the processor, second augmentation data by transforming images within the first training data set having the second class based on the second transform function included in the second data augmentation policy (e.g., S408), and generating, via the processor, a final training data set by combing the first training data set, the first augmentation data and the second augmentation data (e.g., S410).

Further, the method can include training, via the processor, an AI model based on the final training data set to generate a trained AI model (e.g., S412).

In addition, according to an embodiment, the trained AI mode can receive, via at least one sensor (e.g., a camera) in the AI device, an input image and input the input image into the trained AI model, and execute a function based on detecting an object or face within the input image by the trained AI model. For example, the AI model can control a robot to execute an action, such as avoid an obstacle, drive in a certain direction, provide a personalized service to a recognized user, move a robot arm to grasp a detected object, etc.

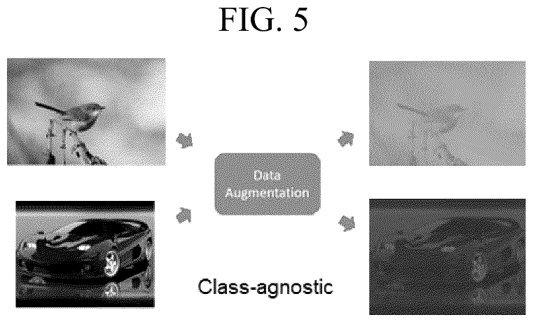

FIG. 5 shows a comparative example of class-agnostic data augmentation. For example, in a class-agnostic approach, the same transform function can be applied to an image including a bird and an image including a car, in order to produce more training data for training the AI model (e.g., two new images are produced which can be used for training).

For instance, a same type of desaturation transformation can be applied to the bird image and the car image. However, as discussed above, this class-agnostic approach may be effective in producing more training data that can help the AI model to become more accurate at identifying cars, but when using the same desaturation transformation on birds, it may produce more training data that confuses or impairs the AI model's ability to recognize birds.

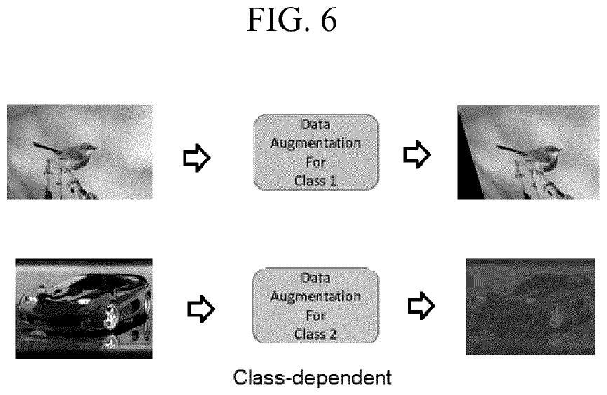

FIG. 6 shows an overview of a method that includes performing a class-dependent data augmentation policy, according to an embodiment.

For example, the method can include recognizing that the input image includes a first class (e.g., a bird) and looks up a first data augmentation policy for the first class which can be a sheer transformation. Thus, in order to produce more training data, the sheer transformation is applied to the original bird image to produce another bird image that is slightly sheered. Accordingly, two different bird images can be used to help the AI model learn how to better recognize birds.

Similarly, the method can include recognizing that the input image includes a second class (e.g., a car) that is different than the first class (e.g., bird) and looks up a second data augmentation policy for the second class which can be a desaturation transformation. Thus, in order to produce more training data, the desaturation transformation can be applied to the original car image to produce another car image that is slightly desaturated. Accordingly, two different car images can now be used to help the AI model learn how to better recognize cars.

According to an embodiment, the different data augmentation policies for the different classes can be stored in a look-up table, an index, an array or other type of data structure in a memory of the AI device.

According to an embodiment, the method can include two parts, a first part can include a process for determining different optimal data augmentation policies for different classes in a first data training set (e.g., original training data set to be augmented), and a second part that includes a process of applying the different data augmentation policies to the first data training set (e.g., a first set of images and corresponding labels) to produce a second training data training set (e.g., an augmented training set) which is larger than the first data training set. The second part can further include training an AI model based on the second data training set (e.g., the augmented training data). For example, the augmented training data can be added to first data training data set to create the augmented training data set.

The AI model to be trained can be based on a deep layer aggregation (DLP). For example, a deep layer aggregation (DLP) based AI model can provide improved performance by connecting information between different layers of a neural network, which can capture both fine details and high-level semantic information, leading to better accuracy and efficiency, especially for image recognition related tasks.

For example, a DLP model can incorporate iterative connections that progressively combine features from shallower to deeper layers, and hierarchical connections that integrate information across different scales and resolutions. However, embodiments are not limited thereto and other types and combinations of models can be used for the AI model, such as convolutional neural networks (CNNs), vision transformers (ViTs), and object detection models, etc.

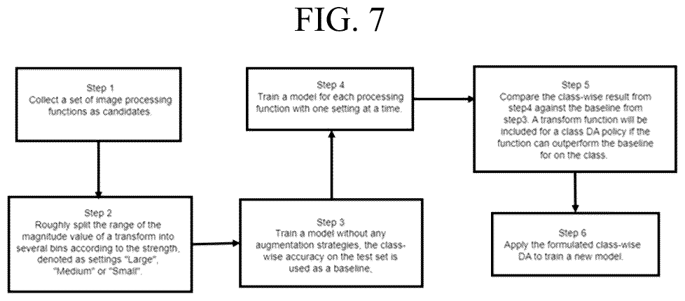

FIG. 7 shows a method that includes determining different optimal data augmentation policies for different classes in a first data training set (e.g., steps 1-5), according to an embodiment. Also, FIG. 7 shows creating an augmented training data set based on the determined data augmentation policies for the different classes, and training an AI model using the augmented training data set (e.g., step 6).

In more detail, the method can include obtaining a pool of transformation functions which can be used as candidates for potentially creating more training data for different classes within a first data set (e.g., an original data set to be augmented). The first data set can be CIFAR-10, but embodiments are not limited there to and other data sets can be used.

For example, CIFAR-10 includes a collection of 60,000 color images divided into 10 classes, with 6,000 images per class. The different classes in CIFAR-10 include plane, car, bird, cat, deer, dog, frog, horse, ship and truck. CIFAR-10 is merely an example of a training data set to be augmented, and other training data sets can be used for augmentation, such as CIFAR-100, ImageNet, CINIC-10, Open Images, etc., according to embodiments and design considerations.

In addition, the pool of transformation functions can include 15 functions, e.g., “shear_x,” “shear_y,” “translate_x,” “translate_y,” “rotate,” “posterize,” “solarize,” “color (saturation),” “brightness,” “contrast,” “sharpness,” “flip,” “invert,” “equalize” and “auto-contrast,” but embodiments are not limited thereto. Other functions can be included or excluded from the pool, according to embodiments and design considerations.

With reference again to FIG. 7, a method of controlling an AI device can include obtaining a group of transformation functions which can be used as candidates for producing augmented training data (e.g., Step 1).

Further, the group of transformation functions can be divided based on varying strength levels or magnitudes (e.g., Step 2). For example, three different strength options can be provided for each transformation function, e.g., a “small” option, a “medium” option, and a “large” option. However, embodiments are not limited thereto, and more or fewer than three options can be provided for adjusting the magnitude of each transformation function. Also, some transformation functions may only have one set option or a default function, e.g., “auto-contrast,” “equalize,” “invert” and “flip” do not have any magnitudes associated with their application.

For example, specific ranges can be set for the transformation functions. A “small” magnitude can mean that the image will be less distorted than for a “large” magnitude. The specific ranges for the transformation functions can include: a) (small: [0, 0.2], medium: [0.2,0.4], large: [0.4, 0.6], ratio of the image size) for the “shear_x” and “shear_y” transformation functions; b) (small: [0,0.15], medium: [0.15, 0.3], large: [0.3, 0.45], ratio of the image size) for the “translate_x” and “translate_y” transformation functions; c) (small: [0, 15], medium: [15, 30], large: [30, 45], degrees) for the “rotate” transformation function; d) (small: [200, 256], medium: [100, 200], large: [0, 100], pixel value) for the “solarize” transformation function; e) (small: [6, 8], medium: [4, 6], large: [2, 4], bits) for the “posterize” transformation function; f) (small: [0.1, 0.3], medium: [0.4, 0.6], large: [0.7, 0.9], relative pixel range) for the “color,” “contrast,” “brightness” and “sharpness” transformation functions. Also, a value within the specific range can be selected at a given probability or distribution for application of the transformation function. However, embodiments are not limited thereto, and different numbers of options can be used and different ranges for the options can be used, according to embodiments and design considerations. For example, using fewer options for adjusting the strength or magnitude used for various transformation functions can ease the computation load, while increasing the number of options can allow for creating more augmented training data and options for training the AI model.

For example, each of the small, medium and large options can specify a range of values for which a strength value can be randomly selected within that specified range for determining how much to modify the original input image according to the corresponding transformation function. According to another embodiment, a strength value can be selected within that specified range according to a given probability distribution, e.g., a normal distribution or Gaussian distribution, etc.

In addition, as shown in Step 3 of FIG. 7, the method can include training a base AI model without any augmentations strategies. For instance, the base AI model can be trained on just CIFAR-10. For example, the class-wise accuracy of the base AI model on a test data set can be used as a baseline for evaluating the different transformation functions and their varying magnitudes. For example, CIFAR-10 includes a collection of 60,000 color images divided into 10 classes, with 6,000 images per class, in which the CIFAR-10 data set can be divided into five training batches and one test batch, each with 10,000 images. However, embodiments are not limited thereto and a different test data set can be used.

Also, according to an embodiment, when training the baseline AI model, all of the training images can go through all of the augmentation transformation functions at a given probability. For example, if there are ten transformation functions, then each of the functions can be applied to an input image with a 10% probability, but embodiments are not limited thereto. In addition, when training the baseline AI model, the transformation functions do not consider the class of the input image. In other words, the transformation functions can be applied with equal chance to an input image regardless of the class of the input image (e.g., different augmentation strategies are not applied, rather the same augmentation strategy can be applied equally regardless of class).

Then, the new images created by the transformations can be added to the original data training set to create a larger augmented data training set to train the baseline AI model, but embodiments are not limited thereto.

According to another embodiment, the baseline AI model can be trained just on the original training dataset without applying any transformation functions or augmented data.

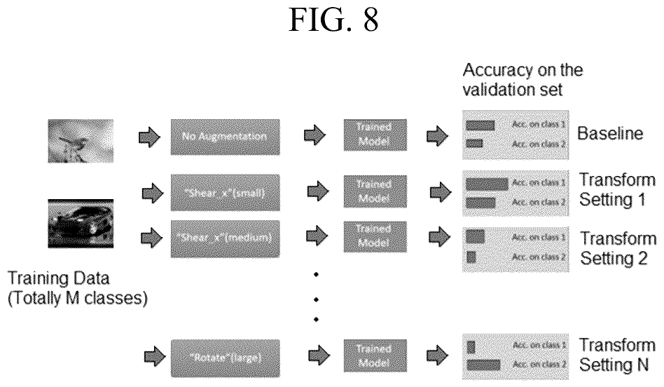

With reference again to FIG. 7, in Step 4, a plurality of AI models can be trained, each of the plurality of AI models using one of the transformation functions with a different strength level for evaluation (e.g., each trained AI model being associated with a different transform setting, see FIG. 8). For example, if the number available transformation functions is 10, and if each of those 10 functions can have 3 different strength levels (e.g., shear_x with small strength, shear_x with medium strength, . . . and so on), then 30 different trained AI models can be produced for evaluating the usefulness of the 30 different transform settings for creating augmented training data for the different classes. The usefulness of each of those 30 different trained AI models can be compared to the baseline AI model that is trained without using any augmentation strategies. For example, either no transformation functions are used to create more training data other than the original data training set, or the same transformation strategy is equally applied for creating augmented data regardless of class, according to embodiments (e.g., see FIG. 8).

As shown in Step 5 of FIG. 7, the class-wise results of each of the trained AI models can be compared with the accuracy results of the baseline AI model. If the accuracy results of one of the trained AI models is higher than the accuracy results of the baseline AI model for a given class, then the corresponding transformation function is selected to be included in a data augmentation policy for that given class. Then, this process is iteratively repeated to determine which transformation functions should be applied to which classes in order to produce augmented training data for the different classes in the original training data set.

In more detail, with reference to FIG. 8, the accuracy results corresponding to each of the M different classes of the baseline AI model when using a same validation data set are compared with the accuracy results of AI models which have been trained with augmented training data according to a different transform setting, where M is a positive number greater than 2 (e.g., 10 classes for CIFAR-10). In other words, each of the trained AI models is trained using additional training data generated from using only one transform setting in order to isolate the individual contribution of that specific transform setting to the accuracy for each of the different classes.

For example, for purposes of explanation, FIG. 8 shows the accuracy results of each model for just two classes, e.g., class 1 (e.g., birds) and class 2 (e.g., cars). As explained above, there is the baseline AI model that was trained on the original training data set without different data augmentation strategies, and there is a different trained AI model for each one of the different transform settings. For example, if there are 10 transform functions each with 3 different settings (e.g., small/medium/large), then 30 trained AI models will be used, but embodiments are not limited thereto. For example, more or less than 30 trained AI models can be used for evaluated different numbers of unique transform settings.

Further in this example, the process continues by determining a different data augmentation policy for each of one of the different classes that are present in the original training data set.

For example, starting with class 1 (e.g., “bird” class), the accuracy of the AI model trained using augmented training data corresponding to Transform Setting 1 (e.g., “Shear_x” with the “small” magnitude setting) is compared with the accuracy of the baseline AI model. In this situation, the results show an improvement over the baseline AI model, which means that Transform Setting 1 is added to the data augmentation policy for class 1. However, the models associated with Transform Setting 2 and Transform Setting N do not show an improvement over the baseline AI model, which means that these transform settings will not be used to create augmented data for class 1 (e.g., “bird” class) when training the final AI model because they would impair the final AI model's accuracy when dealing with class 1. This evaluation process is repeatedly carried out for all the “N” transform settings to determine which transform settings should be applied to class 1.

Further in this example, proceeding to class 2 (e.g., “car” class) the accuracy of the AI model trained using augmented training data corresponding to Transform Setting 1 (e.g., “Shear_x” with the “small” magnitude setting) is compared with the accuracy of the baseline AI model. In this situation, the results also show an improvement over the baseline AI model for class 2, which means that Transform Setting 1 is added to the data augmentation policy for class 2. Similarly, the model associated with Transform Setting N also shows an improvement over the baseline AI model, which means that Transform Setting N is also added to the data augmentation policy for class 2. For example, the data augmentation policy for class 2 includes the transformation “Shear_x” with the “small” magnitude setting, and the transformation “Rotate” with the “large” magnitude setting for creating augmented training data. However, the model associated with Transform Setting 2 does not show an improvement over the baseline AI model, which means that Transform Setting 2 will not be included the data augmentation policy for class 2.

Accordingly, the first data augmentation policy for class 1 will include Transform Setting 1 and Transform Setting 2 for creating augmented training data for class 1 (e.g., bird), and the second data augmentation policy for class 2 will include Transform Setting 1 and Transform Setting N for creating augmented training data for class 2 (e.g., car). Thus, the data augmentation policy for creating more bird training examples is different than the data augmentation policy for creating more car training examples when creating augmented training data to be used for training a final AI model.

The above evaluation process is iteratively repeated for each of the “M” classes that are present in the original training data set and the “N” transform settings, where “M” is a positive number greater than 2 and “N” is a positive number. Thus, there will be “M” different data augmentation policies that will be used to create augmented training data for training a final AI model that will have improved accuracy across all classes. However, embodiments are not limited thereto, and the method can be applied to a single class (e.g., M=1), in which all transforms can be potentially applied on the whole training data and evaluated to determine which transforms improve the accuracy and can be selected for creating augmented training data.

With reference again to FIG. 7, once the “M” different data augmentation policies have been determined, then a final AI model is trained with augmented training data in which each of the different classes has more training data created based on the corresponding transform settings for that specific class. For example, the final AI model is a separate model different from the baseline AI model and the “N” trained models associated with the different transform settings that were used during the evaluation of the different transform settings.

In addition, according to an embodiment, the method can be applied to the specific class of faces for improved face recognition. For example, to determine the best image transformations to be used for creating augmented training data for a face recognition model, the process can include creating a set of potential transformations with varying strengths (e.g., Step 1 and 2 in FIG. 7).

Next, a baseline model can be trained without any augmentation or at least without different augmentation strategies (e.g., the same augmentation can be applied regardless of class). Then, separate AI models can be trained with each transformation setting applied individually. Further, the performance of each model can be evaluated against the baseline AI model, selecting only the transformations that lead to improvement. In this process, all face images can be treated as a single class, even though the model can still be trained to distinguish between individual identities.

For example, in the specific situation of face recognition, the method can further include preparing an input image, X, for processing, by first normalizing its pixel values to fall within the range of 0 to 1. This can be achieved by subtracting the minimum pixel value from all pixels, effectively shifting the range to start at 0. Then, if the maximum pixel value is not 0, all pixel values can be divided by the maximum value, scaling the range to end at 1. This normalization can ensure that all pixel values are represented as proportions between 0 and 1.

Further, the specific augmentation policy for the class of faces can include eight functions selected from among a larger pool of available functions. For example, the specific data augmentation policy for the face class can include the transformation functions of Grayscale, Filp, Rotation, RandomResizedCrop, BrightnessJitter, ContrastJitter, SaturationJitter, and RandomPerspective, each of which is described in detail below.

The Grayscale transformation includes converting a “colorful” RGB input image to grayscale, the Flip transformation includes horizontally flipping the input image, and the Rotation transformation includes rotating the input image around the center point at a given degree, after which zeros are padded to the image and the output will be resized to the same size as the input image.

Further, the RandomResizedCrop transformation includes randomly cropping the input image, e.g., the longest side (height or width) of the crop is set to a range of ratio of the input image, the ratio is uniformly sampled from [0.7, 0.9], the height/width ratio of the crop is uniformly sampled from range [3/4, 4/3], and then the crop is resized to the same size as the original input.

The BrightnessJitter transformation includes jittering the brightness of the input image, in which a constant number is added by the input image. The constant number is uniformly sampled from range [−0.1, 0.1] for each image. The value range of the output is then clipped to range [0, 1].

In addition, the ContrastJitter transformation includes jittering the contrast of the image, in which a constant number is multiplied by the input image. The constant number is uniformly sampled from range [0.9, 1.1] for each image. The value range of the output is then clipped to the range [0, 1].

The SaturationJitter transformation includes jittering the saturation of the input image, converting the RGB input image to HSV format, then a constant number is multiplied by the saturation(S) channel. The constant number is uniformly sampled from [0.9, 1.1]. Then the HSV image is converted back to RGB, and the output value is clipped to [0, 1].

Further, the RandomPerspective transformation includes randomly changing the perspective of the input image using the perspective transform matrix. Given an input image with a size of (height, width), assuming the coordinate of the top left corner point is (0, 0), the coordinate (new_height, new_width) of the transformed image is constrained within the range, uniformly sample “new_height” from [0, 0.25*height] and likewise for “new_width”. This change constraint on the coordinate distance also applies to the other three corners, top right, bottom left and bottom right. Zeros are then padded to the output and the size is rescaled to the same size as the input.

Further in this example, using the above eight transformations for the face class, after standardizing a face image to range [0, 1], the eight functions can be applied on the input image sequentially at a given probability, e.g., p=0.3, for augmentation. The augmented image can be rescaled back to standard range [0, 255] for visualization, or for training the AI model. As discussed above, other image transformation from the available pool that are different than the above eight transformation may not be used to create the augmentation data for the face class. In this way, the AI model can have improved accuracy for face recognition.

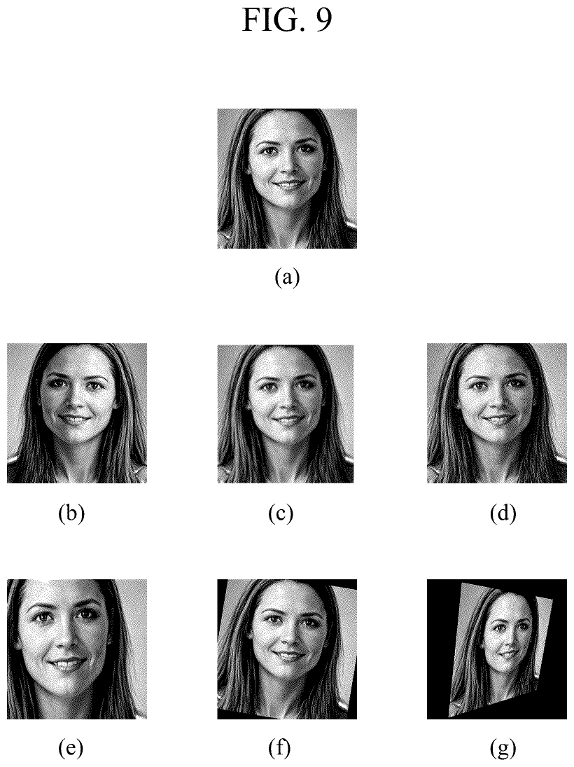

FIG. 9, includes parts (a)-(g) show examples of augmented training data created from one input face image for the face class. For example, FIG. 9, part (a) shows an example input color face image (e.g., image of a woman). Part (b) is augmented data after the Flipped transformation has been applied to the input face image, and part (c) is augmented data after the GrayScale transformation has been applied to the input face image.

Further in this example, FIG. 9, part (d) is augmented data after the color-jitter transformation (e.g., including brightness, contrast and saturation) has been applied to the input face image, part (e) is augmented data after the RandomResizedCrop transformation has been applied to the input face image, part (f) is augmented data after the Rotate transformation has been applied to the input face image, and part (g) is augmented data after the RandomPerspective transformation has been applied to the input face image. For example, the newly created images in parts (b)-(g) can be used as augmented data to train the AI model in addition to the original input training image in part (a), which can improve the model's accuracy for the face class.

In addition, according to an embodiment, to validate the method including the class aware augmentation, the Steps 1-5 in FIG. 7 were applied on the CIFAR-10 dataset to formulate different augmentation policies for each of the classes in CIFAR-10. Then, a new final AI model (e.g., referred to as “ClassAug”) was trained with the class-wise augmentation policies and its accuracy results for the different classes was compared with the accuracy results of the class-agnostic methods of NoAug, AutoAug, RandAug, TrivialAug, and AugMix, as shown in Table I below. Also, a deep layer aggregation DLA network was used as a backbone for the model.

TABLE I

| | Plane | Car | Bird | Cat | Deer | Dog | Frog | Horse | Ship | Truck | Avg. |
|---|---|---|---|---|---|---|---|---|---|---|---|
| NoAug | 0.883 | 0.942 | 0.786 | 0.688 | 0.836 | 0.778 | 0.899 | 0.886 | 0.937 | 0.911 | 0.8546 |
| AutoAug | 0.929 | 0.973 | 0.879 | 0.79 | 0.924 | 0.873 | 0.95 | 0.956 | 0.97 | 0.953 | 0.9197 |
| RandAug | 0.963 | 0.978 | 0.925 | 0.87 | 0.947 | 0.911 | 0.965 | 0.968 | 0.969 | 0.958 | 0.9454 |
| TrivialAug | 0.953 | 0.982 | 0.924 | 0.839 | 0.956 | 0.891 | 0.975 | 0.969 | 0.968 | 0.963 | 0.942 |
| AugMix | 0.932 | 0.949 | 0.823 | 0.74 | 0.872 | 0.801 | 0.936 | 0.926 | 0.934 | 0.93 | 0.8843 |
| ClassAug | 0.967 | 0.985 | 0.933 | 0.923 | 0.962 | 0.897 | 0.977 | 0.979 | 0.962 | 0.965 | 0.955 |

As shown above, the method using the class-wise data augmentation policies according to an embodiment has a higher average accuracy across all classes than compared to the average accuracy of the class-agnostic methods. Also, the method according to the embodiment has higher accuracy for nearly all of the individual classes as well (e.g., except for Dog, Ship, and Truck), and the accuracy results were still nearly equal for the few outliers.

According to an embodiment, the AI device 100 can be configured to produce augmentation data and train an AI model based on the augmented training data. The AI device 100 can be used in various types of different situations.

According to one or more embodiments of the present disclosure, the AI device 100 can solve one or more technological problems in the existing technology, such as providing class-specific data augmentation policies for increasing the diversity of training data and a more accurate AI model that can provide object classification related tasks and/or face recognition. For example, the AI device can address to need of being able to automatically generate more useful training data that can be used to produce more accurate AI models.

Also, according to an embodiment, the AI device 100 configured with the trained AI model can be used in a robot, a self-driving vehicle, a surveillance system, etc.

Further, according to an embodiment, the AI device 100 including the trained AI model can perform object classification as a fundamental task, and various down-stream AI applications can be built based on recognizing objects in an image. For example, the AI device can be applied in a wide range of applications to recognize and understand an object in an image. Further, the AI device can improve the accuracy of a face recognition system, thus any devices that use face verification can benefit from the method.

In addition, the AI device including the trained AI model can be applied to various applications including surveillance or personalized solutions for home appliances. For example, a home device configured with the trained AI model can better recognize a specific user, receive a command or query, and provide a more personalized response or answer. Also, the method can effectively augment training data for facial recognition and object recognition, and a more accurate system can be provided and deployed.

Various aspects of the embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

Furthermore, although some aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, PHP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A method for controlling an artificial intelligence (AI) device, the method comprising:
obtaining, via a processor in the AI device, a group of transform functions;
obtaining, via the processor, a first training data set including images and class labels;
obtaining, via the processor, a plurality of data augmentation policies including at least a first data augmentation policy including a first transform function selected from among the group of transform functions for a first class within the first training data set and a second data augmentation policy including a second transform function selected from among the group of transform functions for a second class within the first training data set, the first data augmentation policy being different than the second data augmentation policy;
generating, via the processor, first augmentation data by transforming images within the first training data set having the first class based on the first transform function included in the first data augmentation policy;
generating, via the processor, second augmentation data by transforming images within the first training data set having the second class based on the second transform function included in the second data augmentation policy;
generating, via the processor, a final training data set by combing the first training data set, the first augmentation data and the second augmentation data; and
training, via the processor, an AI model based on the final training data set to generate a trained AI model.

2. The method of claim 1, further comparing:
receiving, via at least one sensor in the AI device, an input image;
inputting the input image into the trained AI model; and
executing a function based on detecting an object or face within the input image by the trained AI model.

3. The method of claim 1, further comparing:
generating, via the processor, the plurality of data augmentation policies based on evaluating accuracy results of a baseline AI model trained on the first training data set without any additional data augmentation strategies, accuracy results of a first AI model trained according to a first transform setting corresponding to the first transform function and accuracy results of a second AI model trained according to a second transform setting corresponding to the second transform function.

4. The method of claim 1, wherein the generating the plurality of data augmentation policies includes:
training a plurality of AI models to generate a plurality of trained AI models, each of the plurality of trained AI models being trained with different augmentation data generated by a different transform setting for a transform selected from among the group of transform functions;
comparing accuracy results of each of the plurality of trained AI models for the first class with accuracy results of a baseline AI model trained based on the first training data set for the first class; and
adding transform settings corresponding to trained AI models from among the plurality of trained AI models that have higher accuracy for the first class than the accuracy results of the baseline AI model for the first class to the first data augmentation policy.

5. The method of claim 4, wherein the generating the plurality of data augmentation policies further includes:
comparing accuracy results of each of the plurality of trained AI models for the second class with accuracy results of the baseline AI model for the second class; and
adding transform settings corresponding to trained AI models from among the plurality of trained AI models that have higher accuracy for the second class than the accuracy results of the baseline AI model for the second class to the second data augmentation policy.

6. The method of claim 4, wherein at least one transform function among the group of transform functions has a small setting, a medium setting and large setting, the small setting configuring a first range of magnitude values for applying the at least one transform function, the medium setting configuring a second range of magnitude values for applying the at least one transform function that is greater than the first range of magnitude values corresponding to the small setting, and the large setting configuring a third range of magnitude values for applying the at least one transform function that is greater than the second range of magnitude values corresponding to the medium setting, and
wherein the plurality of trained AI models include a first trained AI model corresponding to the at least one transform function applied based on the small setting, a second trained AI model corresponding to the at least one transform function applied based on the medium setting, and a third trained AI model corresponding to the at least one transform function applied based on the large setting.

7. The method of claim 4, wherein the baseline AI model is trained on class-agnostic augmentation data.

8. The method of claim 1, wherein the group of transform functions includes one or more of a shear_x transformation function, a shear_y transformation function, a translate_x transformation function, a translate_y transformation function, a rotate transformation function, a posterize transformation function, a solarize transformation function, a color transformation function, a brightness transformation function, a contrast transformation function, a sharpness transformation function, a flip transformation function, an invert transformation function, an equalize transformation function, an auto-contrast transformation function, a grayscale transformation function, a RandomResizedCrop transformation function, a BrightnessJitter transformation function, a ContrastJitter transformation function, a SaturationJitter transformation function, and a RandomPerspective transformation function.

9. The method of claim 1, wherein classes in the first training data set include one or more of face, plane, car, bird, cat, deer, dog, frog, horse, ship and truck.

10. The method of claim 1, wherein the trained AI model is based on deep layer aggregation (DLP) configured to connect information between different layers of a neural network.

11. An artificial intelligence (AI) device, comprising:
a memory configured to store data augmentation policy information and training data; and
a controller configured to:
obtain a group of transform functions,
obtain a first training data set including images and class labels,
obtain a plurality of data augmentation policies including at least a first data augmentation policy including a first transform function selected from among the group of transform functions for a first class within the first training data set and a second data augmentation policy including a second transform function selected from among the group of transform functions for a second class within the first training data set, the first data augmentation policy being different than the second data augmentation policy,
generate first augmentation data by transforming images within the first training data set having the first class based on the first transform function included in the first data augmentation policy,
generate second augmentation data by transforming images within the first training data set having the second class based on the second transform function included in the second data augmentation policy,
generate, via the processor, a final training data set by combing the first training data set, the first augmentation data and the second augmentation data, and
train an AI model based on the final training data set to generate a trained AI model.

12. The AI device of claim 11, wherein the controller is further configured to:
receive, via at least one sensor in the AI device, an input image,
input the input image into the trained AI model, and
execute a function based on detecting an object or face within the input image by the trained AI model.

13. The AI device of claim 11, wherein the controller is further configured to:
generate the plurality of data augmentation policies based on evaluating accuracy results of a baseline AI model trained on the first training data set without any additional data augmentation strategies, accuracy results of a first AI model trained according to a first transform setting corresponding to the first transform function and accuracy results of a second AI model trained according to a second transform setting corresponding to the second transform function.

14. The AI device of claim 11, wherein the controller is further configured to:
train a plurality of AI models to generate a plurality of trained AI models, each of the plurality of trained AI models being trained with different augmentation data generated by a different transform setting for a transform selected from among the group of transform functions,
compare accuracy results of each of the plurality of trained AI models for the first class with accuracy results of a baseline AI model trained based on the first training data set for the first class, and
add transform settings corresponding to trained AI models from among the plurality of trained AI models that have higher accuracy for the first class than the accuracy results of the baseline AI model for the first class to the first data augmentation policy.

15. The AI device of claim 14, wherein the controller is further configured to:
compare accuracy results of each of the plurality of trained AI models for the second class with accuracy results of the baseline AI model for the second class, and
add transform settings corresponding to trained AI models from among the plurality of trained AI models that have higher accuracy for the second class than the accuracy results of the baseline AI model for the second class to the second data augmentation policy to generate the plurality of data augmentation policies.

16. The AI device of claim 14, wherein at least one transform function among the group of transform functions has a small setting, a medium setting and large setting, the small setting configuring a first range of magnitude values for applying the at least one transform function, the medium setting configuring a second range of magnitude values for applying the at least one transform function that is greater than the first range of magnitude values corresponding to the small setting, and the large setting configuring a third range of magnitude values for applying the at least one transform function that is greater than the second range of magnitude values corresponding to the medium setting, and
wherein the plurality of trained AI models include a first trained AI model corresponding to the at least one transform function applied based on the small setting, a second trained AI model corresponding to the at least one transform function applied based on the medium setting, and a third trained AI model corresponding to the at least one transform function applied based on the large setting.

17. The AI device of claim 14, wherein the baseline AI model is trained on class-agnostic augmentation data.

18. The AI device of claim 11, wherein the group of transform functions includes one or more of a shear_x transformation function, a shear_y transformation function, a translate_x transformation function, a translate_y transformation function, a rotate transformation function, a posterize transformation function, a solarize transformation function, a color transformation function, a brightness transformation function, a contrast transformation function, a sharpness transformation function, a flip transformation function, an invert transformation function, an equalize transformation function, an auto-contrast transformation function, a grayscale transformation function, a RandomResizedCrop transformation function, a BrightnessJitter transformation function, a ContrastJitter transformation function, a SaturationJitter transformation function, and a RandomPerspective transformation function.

19. The AI device of claim 11, wherein classes in the first training data set include one or more of face, plane, car, bird, cat, deer, dog, frog, horse, ship and truck.

20. The AI device of claim 11, wherein the trained AI model is based on deep layer aggregation (DLP) configured to connect information between different layers of a neural network.
